(19) United States
(12) Patent Application Publication
(10) Pub. No.: US 2008/0243528 A1
(43) Pub. Date: Oct. 2, 2008

(54) Rapid notarization method and system

(76) Inventor: Dusic Kwak, Lorton, VA (US)

Correspondence Address: MAIER & MAIER, PLLC, 1000 DUKE STREET, ALEXANDRIA, VA, 22314, US

(21) Appl. No.: 11/727,292

(22) Filed: Mar. 26, 2007

(51) Int. Cl. G06Q 10/00; G06F 17/00

(52) U.S. Cl. 705/1; 715/268

(57) ABSTRACT

A method and system for signing or notarizing a document. The method and system can include a first party having a document that they wish to have signed and notarized. The document may then be scanned and entered into a database. The document may then be viewed by a first agent located at a facility physically proximate the first party who can then send the notification to a second party that is to sign the document and may have it notarized. The second party, upon receiving the notification, may proceed to a second location physically proximate to the second party. Upon arriving at the second location, the second party may verify their identity to a second agent located at the second location and may proceed to electronically sign the document and have it notarized by the second agent. The document may then be printed with the signatures and notary seal at the first location and given back to the first party.

### BACKGROUND

The background for this application relates generally to the signing and notarization of documents. If a person desires to have another person sign a document and then have the document notarized, a physical copy of the notarized document must at least be sent from the signing and notarizing parties to the original person. This process can take a significant amount of time. For example, if a person has a document in Washington, D.C. that they need to have signed and notarized in Los Angeles, Calif., a variety of time-consuming and often expensive steps must be taken.

In this example, a copy of the original document to be signed and notarized may be electronically transmitted from Washington to Los Angeles, such as using electronic mail (email) or facsimile (fax). This process typically does not require a significant time or money investment. However, after a physical copy of the document is presented to the party who is to sign the document, they must sign the document in the presence a properly licensed notary. The notary may then also sign the document. Next, the notary may apply their seal, which often involves creating an imprint on the document that can not be reproduced through traditional means, such as photocopying. However, after the notary applies their seal and signs the document, the physical document must then be transported back to the original party.

In order to transport the document to the original party, any of a variety of shipping techniques may be utilized. Examples include traditional mail, shipping companies and couriers. However each of these manners of returning the document to the original party may take a significant amount of time, usually not fewer than twenty four hours. Additionally, shipping can cost a significant amount of money and the amount of money typically increases based upon the quickness with which a party desires their shipment to be made. Therefore, it may be desirable to offer a system that would allow a person to obtain a signed, notarized document from great distances with very little time or money expended.

### SUMMARY OF THE INVENTION

An embodiment of the invention includes a method for obtaining a signature and optionally a notary seal on a document. This embodiment can include scanning, by a first party, a document into a database and notifying a second party via a notification that the document is available to view at a remote location. The embodiment may then include verifying, by an agent at the remote location, that the second party should view the document and viewing the document at a remote location. Then there may be a signing, by the second party, of the document electronically and signing, by the agent at the remote location, of the document electronically. The document may then be printed at a location local to the first party and the procedure used to obtain the signature may be verified before the document is returned to the first party.

Another exemplary embodiment includes a system that can include a first party having a document that they wish to have signed and notarized. The document may then be scanned and entered into a database. The document may then be viewed by a first agent located at a facility physically proximate the first party who can then send the notification to a second party that is to sign the document and may have it notarized. The second party, upon receiving the notification, may proceed to a second location physically proximate to the second party. Upon arriving at the second location, the second party may verify their identity to a second agent located at the second location and may proceed to electronically sign the document and have it notarized by the second agent. The document may then be printed with the signatures and notary seal at the first location and given back to the first party.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing a method and system for obtaining a signature and notarization.

FIG. 2 is an exemplary diagram showing a method and system for obtaining a signature and notarization.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention,” “alternative embodiment(s),” and “exemplary embodiment(s)” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Additionally, some exemplary embodiments include network adapters that may also be coupled to the system to enable the data processing system to become coupled to other data processing systems or remote printers or storage devices through intervening private or public networks. Modems, cable modems and Ethernet cards are just a few of the currently available types of network adapters.

Also, exemplary embodiments may include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, ACCESS, etc.), an object-oriented database management system (ODBMS), a file system or another conventional database package as a few non-limiting examples. The databases can be accessed via a Structure Query Language (SQL) or other tools known to one having skill in the art.

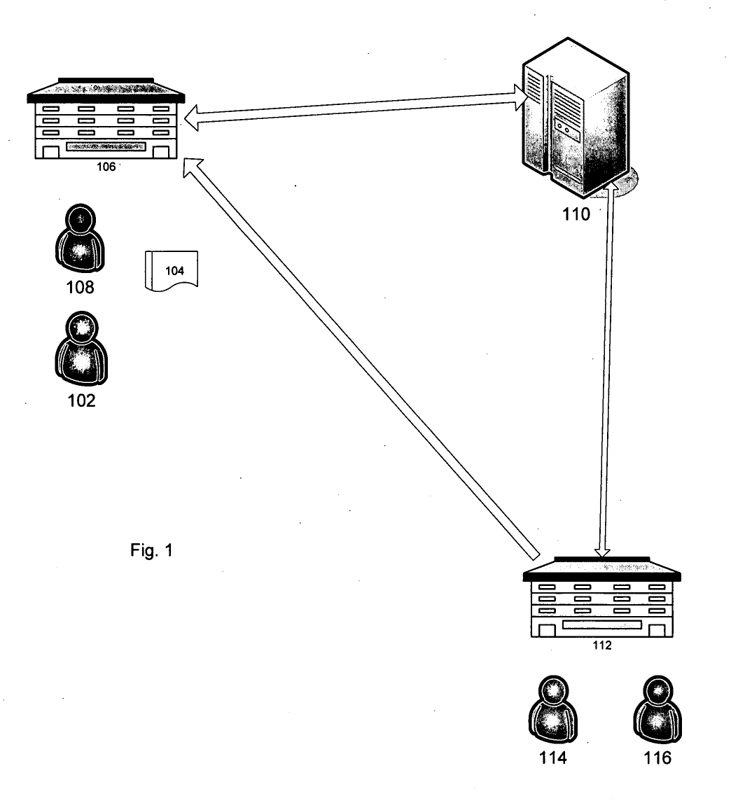

In one exemplary embodiment, as shown in FIG. 1, a document sent by a first party may be signed by a second party, notarized and returned to the first party in a short amount of time. In this embodiment, a transmission and notarization system 100 can allow a first party 102 to transmit a document 104 from a local location 106 to a remote location 112 and back to the local location 106 in a short amount of time. For example, first party 102 may have document 104 that may be needed or desired to be signed and notarized. The second party 114 who may need to sign document 104 may be located at a significant physical distance from first party 102, which could typically cause a significant amount of time to expire between the time when first party 102 needs or desires to have document 104 signed and notarized. Thus, in one exemplary embodiment, first party 102 may make an electronic copy or scanned version of document 104. The electronic copy of document 104 may then be uploaded to a central database 110 at either the first party's 102 home or any other location local to first party 102. For example, first party 102 may log into a website or any other online portal, for example by entering a user name and password. The website may have an access fee or membership fee that first party 102 may have to pay before he or she accesses the website or before he or she transmits any data. Additionally, the website may be maintained by any entity, for example the United States Post Office or any other shipping or transmitting agent, such as Federal Express, United Parcel Service or the like. Alternatively, the website could be maintained by any business or association having a variety of branch locations in a variety of different locales.

In a further exemplary embodiment, before, during or after uploading document 104, first party 102 may enter any desired transmission data that he or she desires. For example, first party 102 may enter any desired contact information for second party 114, such as their address, phone number and email address. Additionally, first party 102 may enter the desired actions that they wish to happen, for example the transmission of document 104, the signing and notarization of document 104 by second party 114 and remote agent 116, respectively, and the return of the signed and notarized document 104 to first party 102.

After the electronic copy of document 104 is uploaded to a database, the document 104 may be accessed and/or transmitted. In one exemplary embodiment, the electronic copy of the document may be accessed, for example on a secure network, by a local agent 108 at a local location 106. Local location 106 may be a branch of the same entity that maintains the website or online portal described above, such as the United States Post Office, any other type of post office or any other shipping or transmitting agent, such as Federal Express or United Parcel Service. Alternatively, local location could be any business or service with a variety of branches, such as a bank or convenience stores, for example 7-11. Local agent 108 may review the electronic copy of document 104 or otherwise access the electronic copy of the document 104 at local location 106 in order to determine that it is in proper condition for transmittal to remote location 112, which may also be a branch of the entity described above, such as the United States Post Office, any other type of post office or any other shipping or transmitting agent.

After it is determined that document 104 is in the appropriate condition for transmittal, document 104 may be transmitted from central database 110 to remote location 112. Remote location 112 will be a location that is physically proximate second party 114 or is otherwise at a desired location that is accessible to second party 114. Remote location 112 may be determined based upon information that first party 102 inputted before, during or after uploading document 104 to central database 110 or may be information that first party 102 otherwise provides to local agent 108. Before, during or after document 104 is transmitted from central database 110 to remote location 112, second party 114 may receive notification that their presence is desired at remote location 112. For example, using the information first party 102 may have entered before, during or after uploading document 104 to central database 110 or using information provided to local agent 108, an email, phone call, facsimile or any other manner of providing notification known to one having ordinary skill in the art may be used to contact second party 114. This notification can provide second party 114 with information saying, for example, that their presence is desired at remote location 112 for the purpose of signing and notarizing document 104.

Upon receipt of the notification, second party 114 may travel to remote location 112. In one exemplary embodiment, upon the arrival of second party 114 to remote location 112, document 104 may be displayed to second party 114 and remote agent 116. However, in order to view document 104, second party may have to present some form of identification, such as a driver's license, and/or some other type of information, such as a confirmation number or password that could be found in the notification, to remote agent 116. Document 104 may be displayed in any manner, for example electronically on a display or printed and physically shown on paper. Second party 114 may then review document 104 as desired. After reviewing document 104, second party 114 may then sign document 104. The signing of document 104 may take place electronically, for example through the use of a stylus and a touch pad or electronic signature block, or in any other manner known by one having ordinary skill in the art, with the signature of second party 114 being electronically imprinted on document 104, as is also known in the art. Remote agent 116, who may also be a notary, may witness the signing of document 104 by second party 114. In his or her capacity as a notary, remote agent 116 may then electronically affix their notary seal to document 104. The affixing of the notary seal by the second party 114 can be done in any of a variety of manners which will be discussed in more detail below with respect to additional exemplary embodiments. Remote agent 116 may then electronically sign document 104 as a final act of being a witness to the signing of second party 114.

After document 104 has been signed by both second party 114 and signed and notarized by remote agent 116, it may be transmitted, via central database 110, to local location 106. At local location 106, document 104, including the signature of second party 114 and the signature and notary seal of remote agent 116 may be printed. After document 104 has printed, local agent 108 may review the signatures and seal and affix his own signature. The signature of local agent 108 may be accompanied by a statement on document 104, such as an attestation statement, indicating that the signature of second party 114 was witnessed by remote agent 116 and that the signature and seal of remote agent 116 were appropriately affixed and transmitted according to standard practices. The printed document 104, with the appropriate, desired or necessary signatures, seal and statement or statements may then be returned to first party 102. Thus, in this exemplary embodiment, document 104 may be signed and notarized by the appropriate parties in a short amount of time and without the need to ship a physical document to a remote location. Additionally, if second party 114 responds to the notification and proceeds to remote location 112 in a short amount of time, document 104 may be signed, notarized and returned to first party 102 in a very short amount of time, for example less than an hour.

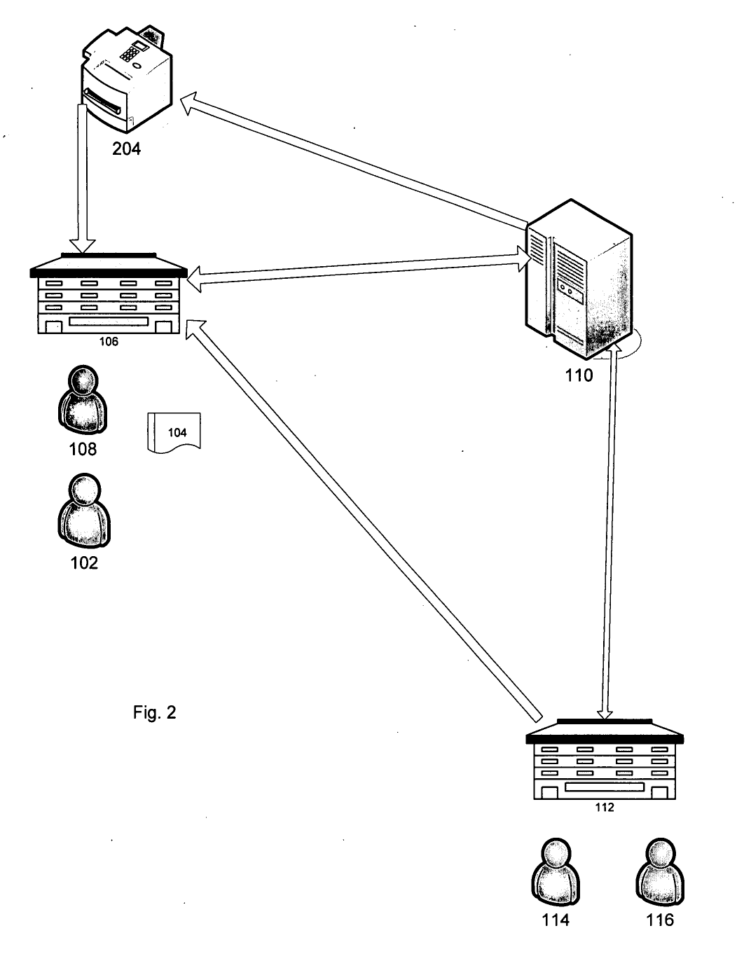

In another exemplary embodiment, as shown in FIG. 2, a first party may again have a document notarized in rapid fashion. However, in this embodiment, the physical application of the signature of a second party and the application of a signature and a seal by remote agent may all be performed in a single, local location. Here, similar to the exemplary embodiment described above, first party 102 may upload document 104 that is desired to be signed and/or notarized. Document 104 may again be uploaded to central database 110. Alternatively, first party 102 may also bring document 104 to local location 106 where document 104 may be scanned and entered into central database 110.

Further, in this exemplary embodiment, after document 104 is deemed appropriate to be transmitted and after a notification is sent to second party 114, second party 114 may travel to remote location 112. At remote location 112, remote agent 116, who may again be a notary, may be present to provide second party 114 with access to document 104 following the presentation of the appropriate identification and/or information by second party 114 to remote agent 116.

After second party 114 reviews document 104, second party 114 will again proceed to sign his or her signature with a stylus in an electronic signature block. However, in this exemplary embodiment, the movement of the stylus on the touchpad or signature block may be recorded by an associated computer that is capable of recording and storing the motions of the stylus on the signature block. The stored motions may then be transmitted, for example in real time or as soon as they are recorded and stored, via a secure connection, such as through a secure intranet or network, to printing mechanism 204. Printing mechanism 204 may be any type of printing mechanism, for example a computer printer or a mechanized arm capable of holding a pen and recreating human handwriting, while also having the ability to imprint seals and stamps. Printing mechanism 204 can have attached thereto a physical copy of document 104 onto which it may print or write data. Additionally, the printing mechanism 204 may be physically located at local location 106, and may be in the physical presence of local agent 104. The stored motions of the signature may then be replicated by the printer or robotic mechanism using standard printing known to one having ordinary skill in the art. Therefore the physical signature of the second party 114 may be physically applied by printing mechanism 204 in the presence of first party 102 and local agent 104.

Remote agent 116 may then apply his or her notary seal to document 104. Because notary seals may require impressions to be made to a document in addition to any ink that may be used, any of a variety of techniques may be used in order for an appropriate seal to be placed on document 104. For example, a seal could be pressed against a signature box and the contours of the seal could be, similar to the above, recorded, stored and transmitted to the printing mechanism 204. Printing mechanism 204 could include one or more mechanical devices capable of replicating the necessary indent and/or ink created by a notary seal. Printing mechanism 204 could also have access to a database of notary seals that could be used in the recreation of seals on a physical document. Alternatively, document 104 could be automatically passed, for example using a conveyor system, through a press that includes a plurality of notary seals. The appropriate notary seal could then be placed on document 104. Document 104 could then be automatically replaced in printing mechanism 204 for the addition of any other desired signatures.

After document 104 is replaced and, similar to the above, when remote agent 116 is to sign document 104, they may use a stylus and touchpad or signature box. The movements of the stylus may then be recorded, stored and transmitted to printing mechanism 204 so that the signature may be written on document 104. In a further exemplary embodiment, document 104 may be attested and signed by local agent 108, thereby verifying that appropriate procedures were performed. Document 104, with the appropriate, desired or necessary signatures, seal and statement or statements may then be returned to first party 102.

Thus, in this exemplary embodiment, a document may be signed by second party 114 and notarized and signed by remote agent 116 without the need for a physical document to be shipped to remote location 112 and returned to local location 106. Additionally, the physical signing application of the signature of second party 114 and the notary seal and signature of remote agent 116 will be performed by printing mechanism 204 on a physical copy of document 104 while in the presence of first party 102 and local agent 104.

Still other applications of the method and system disclosed herein may be utilized. For example, many high schools, colleges and graduate schools accept applications online. Using the above system and method, a school official, similar to first party 102, may receive an application from an applicant, similar to second party 114. The school official may then send a notification to the applicant desiring for them to sign or provide other indication that the application is legitimate or that the applicant intends to matriculate at that particular school. The applicant could then provide a real-time signature to the school official.

In yet another exemplary embodiment, an individual's tax returns could be notarized at the time of submission, for example to indicate that the document was signed and submitted by the proper person. In still another exemplary embodiment, online retailers could utilize the system and method to verify the identity of individuals who purchase their products online. This could be used as a manner of decreasing credit card fraud, identity theft and other types of fraud that are prevalent online. For example, an online retailer could receive a service or product order from an online customer. Then, similar to the above exemplary embodiments, the online retailer could send a notification to the online customer requesting a signature. The online customer could then proceed to a location, such as local location 106, where they could provide identification to a local agent 108 a signature in any of the manners described herein.

In still another exemplary embodiment, any of the above described methods and systems may be used in conjunction with a voting system. For example, absentee ballots are currently mailed, emailed and faxed in by thousands of citizens in the United States and other countries during each election. The absentee ballots may contain an oath and signature, but the identity of the party submitting the ballot is seldom confirmed. Therefore, at a time when a person is to submit a ballot, for example online, they may electronically submit the ballot to the appropriate collection party. The collection party may then provide the person submitting the ballot with a notification to verify their identity. The person submitting the ballot may then travel to the appropriate location, such as local location 106, where they can provide identification to a local agent 108 and provide a signature in any of the manners described above.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for rapidly obtaining a signature, comprising:
scanning, by a first party, a document into a database;
notifying a second party via a notification that the document is available to view at a remote location;
verifying, by an agent at the remote location, that the second party should view the document;
viewing the document at a remote location;
signing, by the second party, the document electronically;
signing, by the agent at the remote location, the document electronically;
printing the document at a location local to the first party;
verifying, by an agent at the location local to the first party, that a desired procedure has been followed by the second party and the agent at the remote location; and
giving the signed document to the first party.

2. The method of claim 1, further comprising:
notarizing the document by the agent at the remote location.

3. The method of claim 1, further comprising:
signing the document in the presence of the agent at the location local to the first party by a mechanized printer using inputs generated by the second party and the agent at the remote location.

4. The method of claim 3, wherein the mechanized printer also provides a notary seal.

5. The method of claim 3, wherein the inputs are generated using a stylus and a signature block.

6. The method of claim 3, wherein the mechanized printer signs the document in real time as the inputs are generated by the second party and the agent at the remote location.

7. The method of claim 1, wherein the online database is accessed through the use of an online interface.

8. The method of claim 1, wherein the location local to the first party and the remote location are branches of the same entity.

9. The method of claim 1, wherein the remote agent verifies the identity of the second party.

10. The method of claim 1, wherein the second party supplies confirmation information from the notification to the agent at the remote location.

11. A system for rapidly notarizing a document, comprising:
a document;
a database;
a first party;
a first agent;
a second party;
a second agent;
a printing device;
a first location proximate the first party and the first agent; and
a second location proximate the second party and the second agent;
the first party inputs the document into the database, the first agent reviews the document at the first location and dispatches a notification to the second party, the second travels to the second location and verifies his or her identity to the second agent, the second party electronically signs the document with a stylus, the second agent electronically notarizes and electronically signs the document with a stylus, the first agent indicates that proper procedure was followed and the now signed and notarized document is given to the first party.

12. The system of claim 11, further comprising:
a printer capable of reproducing handwriting and making notary seals.

13. The system of claim 12, wherein the printer prints the signature of the second party and the signature of the second agent using electronic signals generated by the stylus.

14. The system of claim 13, wherein the printer prints the signature of the second party and the signature of the second agent in real time as the second party and the second agent are electronically signing the document at the second location.

15. The system of claim 11, wherein the first location and the second location are branch offices of the same entity.

16. The system of claim 15, wherein the database is maintained by the entity.

17. The system of claim 11, further comprising:
an online interface where the first party can upload an electronic version of the document and enter address and identification information of the second party.
